(19) United States
(12) Patent Application Publication
(10) Pub. No.: US 2008/0191847 A1
(43) Pub. Date: Aug. 14, 2008

(54) Low frequency wireless identification device

(75) Inventors: Jason August, Toronto (CA); John K. Stevens, Stratham, NH (US); Christopher W. Verge, Hamilton (CA); Paul Waterhouse, Copetown (CA); Kenneth Truong, Scarborough (CA); Michael J. Vandenberg, Erin (CA)

Correspondence Address: MICHAEL J. BUCHENHORNER, 8540 S.W. 83 STREET, MIAMI, FL, 33143, US

(73) Assignee: Visible Assets, Inc., Mississauga (CA)

(21) Appl. No.: 11/633,751

(22) Filed: Dec. 4, 2006

Related U.S. Application Data
(63) Continuation-in-part of application No. 10/481,423, filed on Oct. 7, 2004, now abandoned.
Application No. 10/481,423 is a continuation-in-part of application No. 10/832,853, filed on Apr. 27, 2004, now abandoned.
Application No. 10/832,853 is a continuation-in-part of application No. 11/162,907, filed on Sep. 28, 2005.

(51) Int. Cl. H04Q 5/22

(52) U.S. Cl. 340/10.42

(57) ABSTRACT

A method, system, and associated identification device for identification of an entity, such as a passport for identification of national citizens. The identification device includes: a) a display for displaying a photo and other identification data relating to the entity; b) a wireless communication part operable to receive data queries and transmit data wirelessly. The wireless communication portion includes: i) an antenna operable at a low radio frequency not exceeding 1 megahertz; ii) a transceiver operatively connected to said antenna and operable to transmit and receive data at the aforesaid low radio frequency; iii) a data storage device operable to store data including identification data for identifying the entity; iv) a data processor operable to process data received from the transceiver and the data storage device and to send data to cause the transceiver to emit an identification signal based upon the identification data stored in the data storage device; and v) an energy source operable for activating said transceiver and said data processor. The energy source is selected from a rechargeable battery, a replaceable battery, a solar cell, a pair of electrical connectors connectable to a mating pair of connectors extending to a power supply, and a tag energization antenna operable to receive radio frequency energy from an ambient radio frequency field of a second radio frequency.

### CROSS-REFERENCE TO RELATED APPLICATIONS

This application is related to and incorporates by reference U.S. application Ser. No. 10/820,366, filed Apr. 8, 2004, which application claims the benefit of Provisional Application No. 60/461,562, filed Apr. 9, 2003, both of which are incorporated herein by reference.

This application is related to and claims the benefit of the filing date of, and incorporates by reference, U.S. application Ser. No. 10/481423, filed Dec. 22, 2003, U.S. application Ser. No. 10/832853, filed Apr. 27, 2004, and U.S. application Ser. No. 11/162907, filed Sep. 28, 2005.

### FIELD OF THE INVENTION

This invention relates to a system and method for detecting and tracking packages, freight, animals, people, and other animate and inanimate objects. The invention also relates to novel radio frequency detection tags which are capable of communicating data, such as identification and positional data. In a preferred application, the novel tags can give an active pre-emptive status warning about damage (e.g. due to shock) or a deteriorating condition (e.g. overheating) of the objects to which they are attached. The invention further relates to systems, methods, and identification devices, such as passports and ID cards, to identify animate and inanimate objects, such as individual people.

### BACKGROUND OF THE INVENTION

Hundreds of detection devices that make use of radio frequency have been developed for use in various detection applications, such as tracking animals, for identification of humans within secure areas, and for remote data logging and data collection, tracking of freight, and payment of tolls on toll roads, among other uses. Some of these devices are called RFID (radio frequency identification) Tags, or RF Tags and are often designed to replace fixed barcodes or IDs in many processes. RFID and RF Tags can be categorized into two separate types, active and passive.

RFID Tags are passive, and can be typified as low cost (as low as 10 cents per tag), fixed ID, disposable and usually short-range. Some are long-range but can have only a single tag in the reading field. However, anti-collision methods can be used to read with groups of up to 500 tags within a reading field and it is possible to extend the detection range to a few miles. RFID detection tags work in frequency ranges of 100 Khz to 3 Ghz. (see U.S. Pat. No. 5,517,188, incorporated herein by reference).

RF Tags are active. They typically add a battery to the typical RFID design discussed hereinabove to enable longer reading ranges without powerful readers, and to enable digital clocks, memory, or an optional programmable ID. Cost can be as high as $1,000 and as low as $5, most typically priced in the range of $40. They typically work in a frequency range of 15 Mhz to 3 Ghz.

RFID tags and RF tags both operate as transponders—like an electronic mirror. The basic operating principle is that energy from the antenna of the reader generates an electromagnetic field, which induces a voltage in the coil of the tag and supplies the tag with energy. Data transmission from the reader to the tag is done by changing one parameter of the transmitting field (amplitude, frequency or phase) and reflecting it back. The tag digitally communicates back to the reader by reflecting the electromagnetic field back to the transmitter.

In most cases RFID and RF tags have a fixed ID which cannot be altered. The electronic reader is placed in a critical area where it can read this ID when the tag is activated by the reader, in much the same way as a barcode is scanned by a barcode scanner at a supermarket. In some cases the RF tag can be programmed providing it is removed to an isolated area so that the programmer sees only a single tag, or the providing programmer has prior knowledge of the fixed ID contained in the tag, or a special encoded signal is used for programming (see U.S. Pat. No. 5,517,188, incorporated herein by reference).

These “transponder tags” all have many advantages. The RFID passive versions can cost as low as 10 cents and can, in effect, replace paper barcodes (see U.S. Pat. No. 6,280,544, incorporated herein by reference). The range and distance to read a tag is determined by the tag size and the power and frequency of the signal from the reader. It is possible to develop specialized high frequency transponder tags that can be read from miles away with a powerful high frequency signal or even from a radar scan. A stand-alone transmitting tag with its own transmitter, instead of modulation of a reflective high frequency signal, would consume far too much power for these long range applications. Low frequency (50 Khz to 500 Khz) transponder tags have short ranges, but may have cost advantages and may be readable even when attached to metal shipping containers or steel railroad cars. In most tracking applications a standalone two-way transmitter and receiver as opposed to a transponder-based system used in RF Tags and RFID tags would have too many disadvantages: too expensive, limited range, and require complex transmission RF circuitry, including crystals. Additionally, it would have high power consumption since all transmission power must come from the tag as opposed to the reader's interrogation signal.

A major disadvantage of all transponder based tag designs is that special anti-collision methods (see U.S. Pat. Nos. 6,377,203; 6,512,478; 6,354,493; 5,519,381, all incorporated herein by reference) must be used to read more than one tag within a reader's transmitted field, or alternatively a short range reader must be used to individually address each tag within the larger field (see U.S. Pat. No. 6,195,006, incorporated herein by reference). Also, to program an RF tag requires either a special signal and the tag must be isolated from other tags (only one in the field) or special hardware must be used. This makes it difficult to set up any “networks” of tags with real time inventory or automated real-time detection and tracking of many items all contained within a truck or warehouse. It also makes impossible a network of interactive tags able to freely transmit, be programmed and receive as is the case in any conventional network, and the possibility of real-time freight tracking using the internet is difficult. A second major disadvantage is that to obtain long ranges (100-1,000 feet), higher frequencies are required, and these lead to high power consumption. This power may come from higher activation power of the transmitter signal to the RFID transponder, or from a battery contained within the RF transponder. The batteries are high capacity large (e.g. AA or C alkaline) and life is limited in these applications. Either special measures must be used to either conserve battery life (see U.S. Pat. No. 6,329,944, incorporated herein by reference) or special methods must be used that minimize power for even simple things like clocks or timers (see U.S. Pat. No. 6,294,997, incorporated herein by reference) in RFID or RF Tags.

Finally, active RF tags are typically larger (½ inch thick 4″×5″) and expensive (over $50/unit) because of the battery size. Thin versions typically have limited battery life (two years). Active tags may be used to locate the pallet or shipment within a warehouse, as well as for tracking its progress through a supply chain. Several tags have been developed to include limited data tracking as well as the ability to remotely transmit the data. These tags, however, do not contain LED's or display buttons of any kind, and again represent, in effect, electronic smart barcodes.

Therefore, there is need for a wireless identification device to overcome the shortcomings of the prior art.

### SUMMARY OF THE INVENTION

Briefly, an embodiment according to the present invention provides an identification device for identifying animate and inanimate objects, the identification device including: a display for displaying identification data relating to the entity; a wireless communication part operable to receive data queries and transmit data wirelessly. The wireless communication part includes: i) an antenna operable at a low radio frequency not exceeding 1 megahertz; ii) a transceiver operatively connected to said antenna, the aforesaid transceiver being operable to transmit and receive data at the aforesaid low radio frequency; iii) a data storage device operable to store data including identification data for identifying the entity; iv) a data processor operable to process data received from the aforesaid transceiver and the aforesaid data storage device and to send data to cause the aforesaid transceiver to emit an identification signal based upon the aforesaid identification data stored in the aforesaid data storage device; and v) an energy source operable for activating the aforesaid transceiver and the aforesaid data processor.

Preferably, the aforesaid energy source is selected from a rechargeable battery, a replaceable battery, a solar cell, a pair of electrical connectors connectable to a mating pair connectors extending to a power supply, and a tag energization antenna operable to receive radio frequency energy from an ambient radio frequency field of a second radio frequency.

In a preferred embodiment, the aforesaid identification device comprises a passport of a national citizen, the aforesaid display comprising a photograph of the citizen together with textual information relating thereto.

Advantageously, the aforesaid data storage device may be operable to store a temporal history of data queries that have been received by the aforesaid identification device. Moreover, the aforesaid data processor may preferably be programmed to cause the aforesaid transceiver to automatically transmit the aforesaid temporal history at the aforesaid low radio frequency upon receipt by the aforesaid transceiver of a data signal that corresponds to the aforesaid identification data stored at the aforesaid data storage device.

Preferably, the aforesaid wireless communication portion comprises a clock operable to emit clock signals, the aforesaid data processor being operable to receive the aforesaid clock signals and being programmed to encrypt the stored data in response to the received data and the aforesaid clock signals for transmission by the transceiver as encrypted data, the aforesaid energy source being operable for activating the aforesaid clock.

An embodiment of the present invention further provides a method for monitoring identification data relating to an entity, including the steps of: providing each entity with an identification device (e.g. a passport or ID card); sending the aforesaid received data as a data query to the aforesaid identification device; and thereafter receiving the aforesaid encrypted data and searching a database therewith.

The invention also provides a system for monitoring identification data relating to an entity, the aforesaid system comprising: an identification device, such as a passport, comprising: a) a display for displaying identification data relating to the entity; b) a wireless communication part operable to receive data queries and transmit data wirelessly, the aforesaid wireless communication part comprising: i) an antenna operable at a low radio frequency not exceeding 1 megahertz; ii) a transceiver operatively connected to the aforesaid antenna, the aforesaid transceiver being operable to transmit and receive data at the aforesaid low radio frequency; iii) a data storage device operable to store data comprising identification data for identifying the aforesaid individual; iv) a data processor operable to process data received from the foresaid transceiver and the aforesaid data storage device and to send data to cause the aforesaid transceiver to emit an identification signal based upon said identification data stored in the aforesaid data storage device; v) preferably further comprising a clock operable to emit clock signals, the aforesaid data processor being operable to receive the aforesaid clock signals and being programmed to encrypt the stored data in response to the received data and the aforesaid clock signals for transmission by the transceiver as encrypted data; and v) an energy source operable for activating the aforesaid transceiver, the aforesaid clock and the aforesaid data processor. The system also includes at least one field communication antenna disposed within a distance from each identification device that permits effective communication therewith at said low radio frequency; a reader in operative communication with the aforesaid field communication antenna, the aforesaid reader being operable to receive identification data and encrypted data from the aforesaid identification device; a transmitter in operative communication with the aforesaid field antenna, the aforesaid transmitter being operable to send a data query to the aforesaid identification device; and a central data processor in operative communication with the aforesaid reader and the aforesaid transmitter to transmit a data query and thereafter receive said identification data and encrypted data and to cause search of a database therewith.

According to a preferred embodiment, the aforesaid field communication antenna comprises a large loop arranged to encircle a plurality of entities, each carrying a national passport, at a border control point.

Preferably, the aforesaid energy source comprises a tag energization antenna operable to receive radio frequency energy from an ambient radio frequency field of a second radio frequency, the aforesaid system further comprising a field energization antenna operable to produce the aforesaid ambient radio frequency at the tag energization antenna of the aforesaid entity.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1a is a schematic plan view of an RF tag in accordance with a first embodiment of the invention;

FIG. 1b is a cross-sectional view of the RF tag of FIG. 1a;

FIG. 2a is a schematic plan view of the back of an RF tag in accordance with a second embodiment of the invention;

FIG. 2b is a cross-sectional view of the RF tag of FIG. 2a;

FIG. 3a is a schematic plan view of an RF tag in accordance with the invention, showing its attachment to a surface of a freight box;

FIG. 3b is a cross-sectional view of the RF tag of FIG. 3a;

FIG. 4 is a schematic block diagram depicting the functional components of an RF tag in accordance with the invention;

FIG. 5 is a schematic view of a number of low frequency RF tags attached to freight packages in a warehouse repository, together with a large loop antenna and other components for reading the tags and communicating the information;

FIG. 6 is a schematic view of a number of low frequency RF tags attached to freight packages in a truck repository, together with a large loop antenna and other components for reading the tags and communicating the information to the internet or elsewhere;

FIG. 7 is a schematic view showing the use of a handheld reader to interrogate a selected individual RF tag;

FIG. 8 is a schematic view showing the use of a handheld reader to interrogate RF tags with reader; antennas of different sizes for different communication ranges;

FIG. 9 is a flowchart using block diagrams to describe the use of the invention and its use with the novel RF tags and other components;

FIG. 10 is a table listing of advantages and features of the invention;

FIG. 11 is a schematic view of an identification device in the form of a passport, in accordance with the invention; and

FIG. 12 is a schematic view of a system for monitoring identification data relating to individuals in accordance with the invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a networked RF tag for operating at a low frequency, useful for identifying animate and inanimate objects and individuals. Using lower frequencies (not exceeding 1 megahertz, and typically under 300 Khz) and a base station design that uses large loop antennas (such as 10×10 feet to 500×500 feet) and by transmitting a digital ID to selectively activate a selected client tag, rather than a non-selective signal which would activate many tags simultaneously, we have the ability to read and write to a full network of client tags (which are within the effective range of the loop) using both a simple polled protocol as well as on-demand communications from the client tags. Each such detection tag uses a full duplex transmitter and receiver (transceiver), as opposed to a transponder design used in RFID tags and RF Tags. In addition, these Networked RF Tags (NRF Tags) have significantly reduced power consumption, and long range (1000 sq feet to 10,000 sq feet per antenna), have the power capacity to add displays (e.g. LCD) and light emitting diodes (LED's) and detectors, and buttons so they may become fully interactive “tag clients” (this is not possible with transponder). These low frequencies are generally understood to have very short range (inches), have the disadvantage of limited transmission speed, but have the distinct advantage of operating in harsh environments with reduced interference (see Mar. 19, 2003 RFID Journal “Goodyear Opts for 125 KHz Tire Tag”). However, the range problem is solved by using full duplex communications and a base station with large loop antennas; moreover, the communication speed is not a serious issue in any of the expected applications.

Low frequencies make it possible to use low speed low-power integrated circuits. These integrated circuits may be fabricated using 4 micron CMOS (complementary metal oxide semiconductor) for only 10 to 20 cents and use a standard flat (quarter size) alkaline battery or a lithium battery. The low frequencies provide extremely low power consumption and make it possible to leave the receiver on at all times, drive an LCD display at all times, transmit back to the base station as many as 100,000 times, yet the tag enjoys a lifetime of a minimum five years to a maximum 20 years (lithium battery). The loop antennas have the advantage of communication to modules only contained within the loop, or depending upon the communications mode (AM of FM, or PM) up to one diameter away from the loop. This also makes it possible to estimate the location of an item down to the size of the loop approximately. These non-transponder NRF Tags are novel detection tags which have the ability to transmit and receive in the manner of any radio device and do not depend upon reflection of reader signals.

The NRF Tags have a range of hundreds of feet, and have a long battery life (e.g. 10 years) with miniature button batteries, and only one or two active components. They can do this because they use very low frequencies (below 1 megahertz and preferably under 300 kilohertz) for both transmission and reception.

The novel NRF Tag, is low-cost with full two duplex way transmission and reception, can be fully programmable within the network, and as many as 10,000 or more can all function within a network as clients, with a ten to fifteen year battery life. This tag may be equipped with an LCD display, used for data tracking, and damage control applications. These tags have been specifically designed to easily attach to a package, using tape or other adhesive means. This provides the added advantage of programmability at one site, using a simple hand-held device, attachment to the package at the shipping site, followed by the ability to track the package as well as to log data about the status of the package throughout the entire supply chain. Thus the tag may be used as shipping data to store other shipping information such as addresses, freight contents, weight size, and shipping IDs with full programmable features.

The tag has additional unique features including an LCD display that can optionally provide shipping data information about the shipment such as shipping ID or tracking number or other ID number, as well as light emitting diodes (LED), that can be used for active sorting, and optimal placement either within a warehouse or a truck. The tag may also have several buttons placed on its face that can be used to confirm any action associated with the freight (e.g. it has been sorted or moved), or to scroll information contained in the tag on the LCD display. In addition the tag may be read as it passes through a “reading tunnel,” on a conveyor and/or automatically sorted, similar to systems now based on barcodes. Finally, many such tags may be attached to freight stored in a warehouse, and a single large loop antenna, or multiple overlapping loop antennas placed either in the floor or ceiling or on shelves can be used to interrogate the tags, read data, and status and find the approximate location of the freight in the warehouse. This ability to network many NRF Tags as clients within a region makes many other functions possible within the scope of the invention.

When the freight reaches its destination, the delivery person may optionally remove the tag from the freight, so that it can be reused again by the shipper. Alternatively the tag can stay with the freight and the recipient can take the tag, reprogram it for a return or for another shipment. The design of the tag includes optional rubber buttons placed on the tag back (a flat surface), that may be optionally used to enter a PIN identification number by the shipper prior to attachment to the freight and by the recipient after its removal. This may be used to confirm identities of both shipper and recipient. This same rubber button pattern may also provide for a skid resistant attachment surface to the package, especially if the buttons are made of soft rubber. These buttons also may serve as an electronic detection means confirming that the tag device is actually attached to a package, or has just been removed from the package. For example, the tag's memory could be automatically reset after the tag is removed from the package by detecting that at least two or three of the rear buttons are then simultaneously depressed and released. Alternatively, the same detection system could be used simply to display a message on the LCD that it is now available to be re-programmed and yet not erase the memory.

Another unique feature of this system is its ability to be programmed within the network, providing the server knows the ID of the NRF detection tag client, or by a very low-cost hand-held device, in the warehouse, or in the truck, or at the shipper's site; also, an NRF tag can be programmed at the receiver's site with no knowledge of the clients tag's ID. The hand-held and tag communication range may be easily controlled to a few inches or even a few feet depending upon the size of the loop antenna used for communication contained in the handheld, as well as power supplied to the antennas. This provides the ability for an individual to walk up to a piece of freight with the hand-held, within a warehouse, and interrogate the NRF Tag ID status, or reprogram the tag, or carry out any other maintenance function without any prior knowledge of the shipping ID number or any other shipping data or other information that may be contained in a separate database—it is done based simply by locating the physical freight These features will undoubtedly be limited to specific individuals with the authority to make such changes; however this ability makes maintenance in support of the tags low-cost and allows for maintenance on the warehouse floor.

In addition, low cost detectors for humidity, angle, temperature, acceleration and jog's (Mercury switches) and GPS may be easily added to the NRF Tag as required. With the addition of internal memory such as a data storage device, data associated with these detectors may be logged over time and stored in the tag for reading and documenting the history of the package. This may be particularly important for sensitive high-value electronic items, pharmaceuticals which must be maintained within a narrow temperature range, food items, and other hazardous items or high-valued shipments. In most cases disposable “onetime use” tags used to measure these parameters for freight often cost more than the cost of this electronic damage detection tag. More importantly these electronic tags could provide detailed times and dates when any data parameter changed or an action took place. For example it is possible to identify the location and the precise time when a high-value package was dropped.

A final advantage of this system is its ability to transmit to the Base Station, independent of the base station interrogating the NRF Tag—on-demand tag transmission. This makes it possible if a fault occurs or damage occurs, or say the temperature is out of range for the tag client to send to the base station an alarm condition.

### Communications Protocol

Each NRF tag may have many IDs programmed into its memory. When manufactured all tags have the same master ID, typically 00000000. The handheld or a special programming device (a base station) connected to a computer with limited range, sends out this unique master ID. The tag has an always-on receiver and reads the transmitted ID, it compares this with the IDs contained in its memory and if it finds a match, transmits a signal containing the transmitted ID back to the transmitter, indicating that it is now full open to handle communication. The base station, may then provide the detection tag with one or more unique ID numbers which may simply be a unique tracking number, or other unique ID, as well as any information it may require to function (e.g. instructions to log temperature or physical impacts such as jogs). The tag is also provided with several random numbers stored in its memory that can be used to delay un-solicited transmissions to the base station to minimize likelihood of collisions.

Once programmed the tag may be attached to a piece of freight and placed in a warehouse. In most cases communication is via a simple lolled network system. The base station in the warehouse communicates with the many thousands of tags located on the floor of the warehouse via a tuned loop antenna. The server attached to the base station sends as part of its transmission the tracking number or unique ID to the entire network of tags, and that number is compared by each tag to the numbers contained in the each tag's memory. If the tag does find a match for the transmitted number, then the tag replies to the interrogation with that serial number or with the same ID or tracking number. Provided the numbers are unique only a single tag will reply, and full hand-shake communication can be carried out between the tag and the base station. At the end of the transmission, the base station sends a code to indicate it has completed all communication. The server can do a check-up on all tags by simply polling each tag one after the other with its ID in the same manner as outlined above. The base station may also read and/or harvest the temperature history (logs) or other environmental information history contained in the individual tag's memory.

The novel NRF tags may also initiate communication, by transmitting their ID's to the base station. This could be in response to a button push or in response to an environmental condition (e.g. temperature too high or too low). In the rare case when two tags simultaneously transmit, the IDs will be non-readable and the base station will send out a signal indicating an error has occurred. Two possible protocols may be initiated. The tags may be instructed to re-transmit, using a random delay stored in each tag's memory register, to eliminate the overlap. Alternatively, that server may simply poll all NRF tags in the field, one-by-one, until it locates the two tags that transmitted the signals.

### APPLICATION EXAMPLES

The most basic use of the tag may be simply as a recording of shipping information. Many shippers have far too low a volume of packages to be shipped (three to four week inventory) to justify employing a full shipping system. The average cost for such a system, particularly if it includes a printer, may be thousands of dollars. The same customers, however, often refuse to fill out a paper waybill because of the inconvenience. This NRF tag system simplifies shipping for low volume shippers. In its simplest form, this can provide a very low-cost shipping system to low volume shippers, and reduce costs for the courier, and also provide an enhanced ability to sort, track and bill the customer.

In this basic example the low volume shipper would be provided a hand-held with a low-cost modem built into the cradle. The hand-held can dial out a phone line to a centrally located server, provide the server with information about shipments and also receive updates as well as a customer list. The shipper would simply remove the hand-held from the cradle, scroll down through his personalized address list, and select a correct address. A tag could be placed on the package to be shipped, and the hand-held will program the tag with that address. The NRF tag may optionally record a log of the time it was programmed as well as the identity of the person programming. This identity may be confirmed with a PIN number, entered on the hand-held simply by the serial number of the hand-held itself. Other information may also be contained in the tag such as weight size of the package and service desired (next day, three-day, and so on). When the driver picks the package up he may also scan it with his hand-held, confirming that it's been picked up. When the package is placed in the truck, it may also be tracked and identified with an antenna in the back in the truck. If the truck is equipped with GPS, the GPS coordinates of the package and the fact that it's been picked up may be transmitted again back to the server confirming time and location of the pickup. Thus the packages in the truck may be confirmed periodically by the computer contained in the truck and transmitted back to the central server. This optionally provides the real-time manifest and real-time tracking for the customer as well as for the courier.

When the package arrives at the distribution center, again the novel NRF tag may be read and identified for tracking purposes using either a warehouse antenna or a special reader on a conveyor. This information may be used to automatically sort the package on a conveyor, or it may also be used to manually sort packages. In the manual sort cases all the packages can be placed on a circular conveyor, identified and read by a loop antenna around the conveyor. Once all tags have been identified a sorting program can determine which shipments are to be placed in Truck One for delivery, and the red LED's provided on their attached NRF tags can be flashed. The pickers therefore simply remove packages on the circular conveyor that have a tag with a flashing red LED and put them in Truck One. Similarly, the packages for Truck Two may next be identified with a flashing green LED. Again those packages are removed from the circular conveyor and placed in Truck Two. This procedure can be continued until all packages have been removed and paced into the correct trucks.

Once packages are placed in the correct trucks, they may also be correctly sorted for sequential delivery and then delivered using the same system. For this purpose, the trucks may be equipped with a small server and GPS, and a base station with a loop antenna in the back. The packages can be identified by the server as it reads the GPS location of the truck and as the driver approaches a correct GPS-identified delivery address by simply flashing the LED on the corresponding attached NRF tag. It will be understood that each NRF tag and each server may be provided with an internet protocol (IP) address to enable communication and tracking from other internet addresses of the shipper and of the customers. These new NRF tags therefore provide real-time tracking as well as real-time picking and sorting throughout the entire supply chain with virtually no paperwork.

This same sequence can be used for heavier freight on pallets, or even large high-value items placed on long haul trucks. In many cases, particularly for high-value pharmaceuticals or confectionery items, temperature ranges must be monitored at all times to provide a warning alert for preventing damage (e.g. spoilage). Again this may be done in real-time provided the truck is equipped with a GPS and a loop antenna system, or alternatively the tag may simply actively volunteer data important for the shipment. Of course, this data may be harvested to a central computing system via an IP-address-equipped server once the shipment reaches its destination

These NRF tags may also be used to identify and monitor individuals who are allowed entry into high security areas of using the same basic systems described above, and track individuals within buildings as they move from place to place. The face of the tag in this case could be flat and contain a picture ID, and the back could retain the button array. At critical entry points the user may, for example, be required to enter in a PIN number using buttons on the NRF tag as his positive identification.

### Detailed Description of Other Embodiments

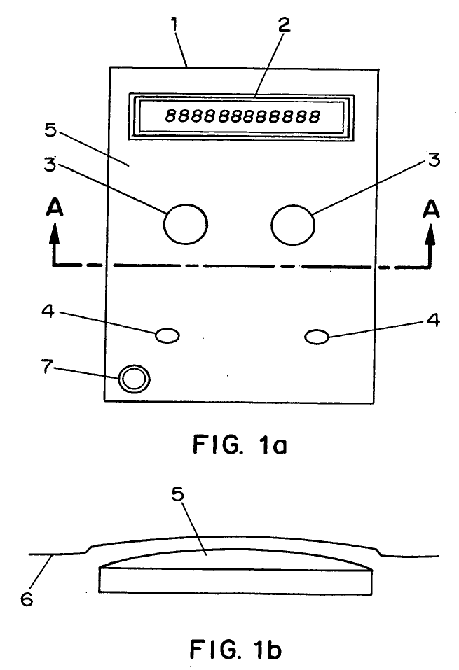

An embodiment of a freight damage alert RF tag 1, in accordance with the invention, is shown in FIG. 1a, which illustrates the front of RF tag 1, and FIG. 1b, which shows a cross-section A-A thereof. This front view includes an optional LCD display 2, an optional set of buttons 3, and an optional set of light emitting diodes (LED) 4. The LED's may be different colors. The display 2 can be used to show the waybill number, or other shipping information, while the buttons 3 can be used to confirm actions in the warehouse or truck or alternatively may be used to scroll information up and down on the display 2. The LED's 4 are useful for selecting and placing freight both in the warehouse as well as in the truck. Tag 1 may be provided with a hole 7 to help attach the tag to freight packages.

One unique feature of the design is that the face 5 of the tag 1 is convexly curved to a thin peripheral edge (see FIG. 1b) so that conventional tape or specialized transparent adhesive film (TAF) 6 can be used to hold the tag in place on the package with no exposed edges. The curved face 5 offers a strong surface for the adhesive on the tape or TAF 6 and does not provide any edges so the tag 1 can be knocked off the package. However the tag 1 may be easily removed when necessary by simply grabbing the corner of the tape 6 and peeling off. This makes it easy to retrieve the tag 1 upon delivery if necessary. It also makes it easy to recycle tags for use on many packages and many repeated uses. Moreover, a suitable device or means may conveniently be provided for attaching the back of tag 1 to a freight package.

Tags 1 may also be introduced that have no LCD display 2, no buttons and no LEDs 4, at a reduced cost. These inexpensive NRF tags may be used simply to data log the status of the package throughout its shipment lifecycle.

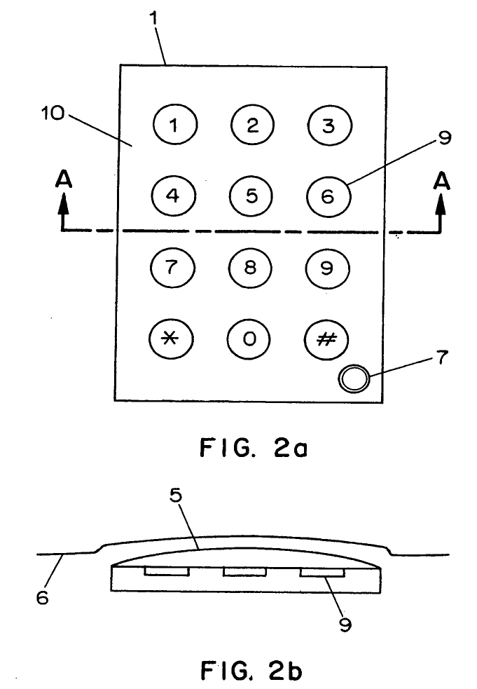

FIG. 2a shows the back view of freight damage alert tag 1, while FIG. 2b shows a cross-section along A-A thereof. Buttons 9 may be optionally placed on the flat back surface 10 of the tag. These buttons 9 may be of soft rubber or other compliant material and, as a result, may offer a cushioned back making it more difficult for the tag 1 to move laterally on the package surface after attachment. The compliant material should have sufficient tensile strength to allow the buttons 9 to resume their original shape after deformation. The compliance of the buttons 9 will also serve as a shock absorber for the object.

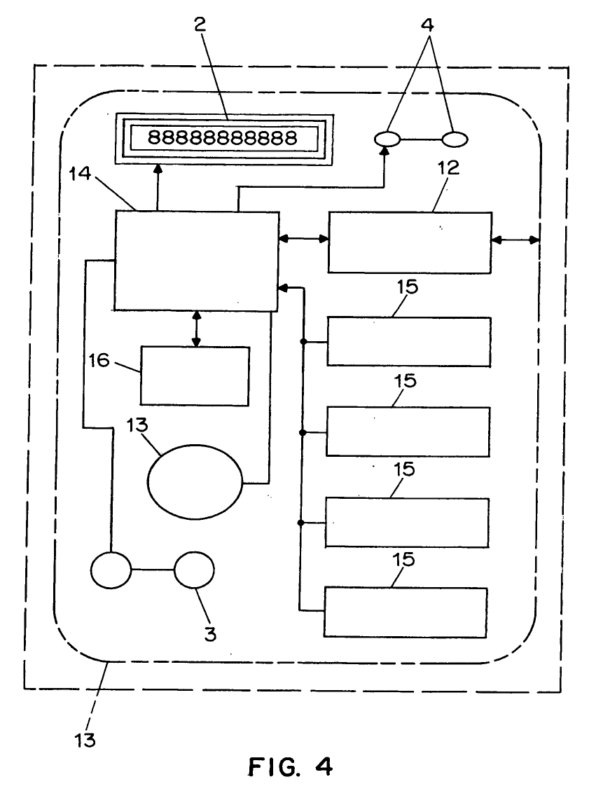

Additionally these buttons 9 may also be used to detect the fact that the tag is actually attached to the package. If more than one button 9 is depressed it becomes clear to the microprocessor provided on tag 1 (see FIG. 4) that the tag 1 is in direct contact with a surface of some kind, such as a freight package, and the pressure has been applied that is necessary to depress all buttons 9.

The same buttons 9 may also be used to confirm identity of the shipper or recipient via PIN numbers. For example, the truck driver may deliver the freight to a recipient, remove the tag 1 and ask the recipient to enter a PIN number on the keypad of buttons 9. Alternatively, the keypad 9 on the back 10 may be used to actually program the tag 1 for a specific destination. The shipper may have a list of destinations printed on a piece of paper each with a unique two digit ID. He may enter the two digit number on buttons 9 followed by the “#” sign to program the shipper's address in the tag 1. That number then appears on the LCD 2 to confirm that it has been programmed for that destination and the shipper may attach tag 1 to the package. This eliminates the need for a shipping system as well as even a low cost hand-held reader. This can significantly reduce cost and save time for the shipper, the courier, and the recipient.

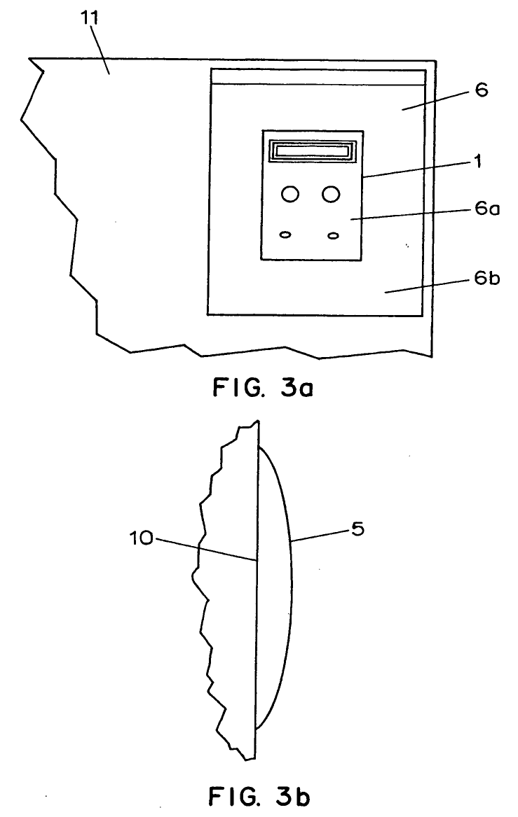

FIG. 3 shows the shape of tag 1 in the preferred attachment means for the tag 1. As can be seen in FIG. 3b, the front face of tag 1 is gently curved from the top, bottom and left edge to form an ellipse. This provides a continuous surface with the package for transparent adhesive film (TAF) 6 to make contact and hold the tag 1 in place (on freight package/box 11) without any exposed tag edges. Sharp edges might be caught during shipment and accidentally knock the tag from the face of the package. This system makes it easy to stick tag 1 on the surface of the package at a very low-cost, and also to remove the tag 1 when necessary.

It is also optionally possible to emboss an area 6a in the TAF attachment means 6 to the actual shape of the tag 1 so that the thickness of the tape 6 may be increased and conform to the shape of the tag 1. These adhesive attachment films 6 may be attached to waxed heavy backing paper and provided to the customers so that attachment becomes quick and easy. It may also be possible in some cases to add an additional piece of transparent film in front of the adhesive film to form an envelope 6b. This envelope 6b can be used for waybills and other documents, particularly useful if the tag does not have an LCD 2 or other optional features.

FIG. 4 is a block diagram showing functional components of a typical freight damage alert tag 1. The heart of the freight damage alert tag is a custom radiofrequency modem 12, created on a custom integrated circuit using 4 micron CMOS technology. This custom modem 12 is designed to communicate (transmit and receive), through a loop antenna 13, made of thin wire wrapped many times around the outside edge of the tag 1. All communications take place at very low frequencies (e.g. under 300 kHz). By using very low frequencies the range of the tag 1 is limited; however power consumption is also greatly reduced. The receiver of modem 12 may be on at all times and hundreds of thousands of communication transactions can take place, while maintaining a life of many years (e.g. up to 15 years) for battery 8. The typical freight NRF tag 1 may also include a memory 16 and a four bit microprocessor 14, using durable, inexpensive 4 micron CMOS technology and requiring very low power, with onboard LCD drivers, to control and drive the LCD display 2, as well as drivers for the LED's 4 and the ability to detect and read analog voltages from various optional detectors 15 and read inputs from buttons 3. For example, the tag 1 may contain a humidity detector and angle detector temperature detector, along with a jog detector.

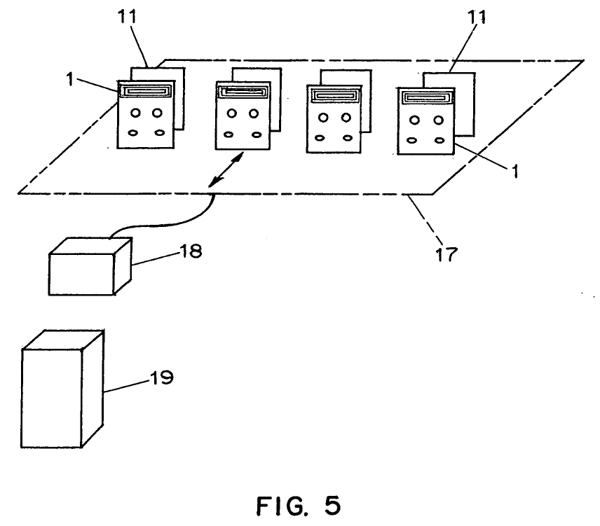

FIG. 5 shows how these novel NRF tags 1 may be placed as clients within a network served by larger loop antenna 17 in a warehouse setting. The larger antenna 17 may be placed in the floor, ceiling or around shelves containing the freight 11. One additional advantage of using low-frequency communication for the system, is the fact these low (e.g. 300 kHz) frequencies do not reflect from steel or metal. In fact, they are often enhanced and refocused effectively by steel shelves or other large iron frames. In many cases the antenna 17 may simply be wrapped around large steel shelves and the tags 1 will all be contained within the inductive low-frequency field. The loop antennas 17 can be up to several hundred feet around. However, as they get larger, the ability to detect individual tag 1 decreases, and the power required to transmit to the tags 1 increases. Low-frequency communication has relatively low noise with antennas 17 in the range of 100 feet by 100 hundred feet, however at 500 feet by 500 feet they begin to detect thunderstorms occurring at a distance—often within 4 or 500 miles away from the antenna 17. Thus, the optimal size for these antennas 17 is on the order of about 100 by 100 feet. However, many such antennas 17 can be placed within a warehouse to create a checkerboard array for communication to any point. This also makes it possible to localize a specific tag 1 within a large warehouse at least within the distance of an antenna square. A single base station 18 can be used to connect to all such antennas 17 by time division multiplexing, or the like.

The antenna 17 is connected to a base station 18 which in turn is operatively connected to a server 19 or other computer controlling mechanism. The base station 18 is able to transmit and receive at much higher power than the tags 1, but as long as the tags 1 are contained within a loop 17, base station 18 can identify and talk to each tag 1 individually. The optimal protocol for this network is for the base station 18 to address the tag 1 based on a known ID. In other words, the optimal protocol requires that the server 19 have a database of IDs found in the loop antenna 17 when using networks of tags 1. As will be understood, for addressing of an individual tag 1 from the internet, the tag 1 may be provided with an IP address.

However, it is possible to actively talk to each tag 1 individually and program it to not respond to a given signal transmitted by the base station 18, such as a chirp command. In other words this chirp command tells all tags 1 that unless they have been programmed to not respond with their ID, to respond with their ID. If a tag 1 exists in the loop 17 that is not in the database it will transmit its ID with the chirp command. If multiple tags 1 exist in the database with unknown IDs they will talk together, and the base station 18/server 19 combination can detect an ID collision. It is then possible to retransmit the chirp signal, but have the tags 1 transmit back with a random delay, so that IDs do not overlap. This process may be repeated until all IDs are found within the loop 17. Other standard methods used in networks may be used to carry out “binary” searches, to illuminate certain addresses until all tags 1 again are identified. In most routine cases however the server 19 will have prior knowledge from the hand-held reader or other sources of tags and all IDs contained in the loop.

The server 19 may, on a periodic basis, interrogate each tag 1 to obtain a current temperature, status button pushes, and so on. The same server 19 may also selectively flash LEDs to indicate that the package or piece of freight 11 should be moved to another area, or can selectively flash LEDs to indicate which packages are placed first in a truck, or can selectively flash LEDs and change the display to provide other information to workers on the warehouse floor. Moreover, it should be understood that once a package is removed from the loop 17, the server 19 can detect that it has been removed and indicate that it is no longer in the database.

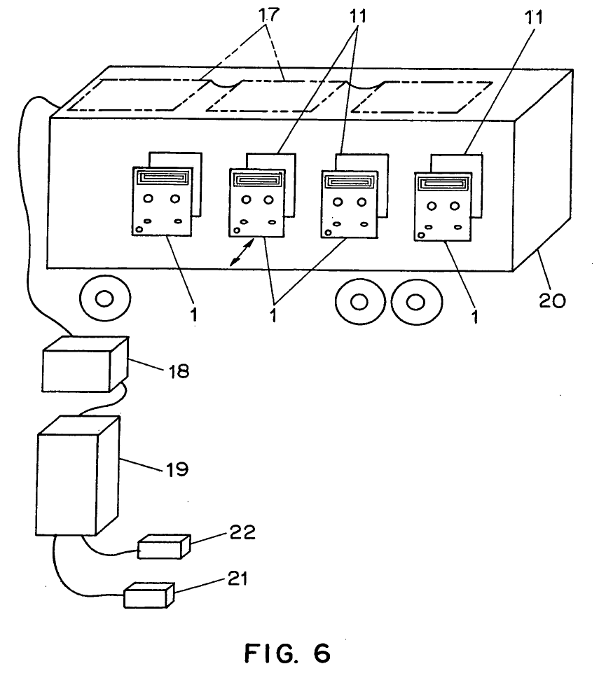

FIG. 6 shows a similar system as is depicted in FIG. 5, except that it is contained in the trailer of a truck 20 as the repository for the freight boxes 11. Again the system comprises a truck server 19 and an optional in-truck data communications means 21, which comprises a digital cell phone or satellite link. An optional in-truck GPS system 22 may also be included as an input to the server 19. The server 19 then sends commands to a base station 18 (similar to the one depicted in FIG. 5) which may in turn connect to an array of antennas 17 that may be placed either in the ceiling of the truck 20 or in its floor to provide for full two-way communication (reception/transmission, or “Rx/Tx) between server 19 and tags 1.

The server 19 may, on a regular basis, interrogate all tags 1 contained in the truck 20, locate tags 1 that are not contained in the database of server 19 and provide real-time confirmation of manifest or status of the freight 11. By using the GPS input 22 about the changing location of truck 20 during its travels, this GPS information may be added to the information in the database of server 19 to thereby provide real-time tracking of individual freight items 11 as the truck 20 travels. In addition the server 19 may confirm the status or condition of the freight 11 (e.g. temperature, angle in real-time) by reading the sensors 15 and transmitting them via the in-truck data communications system 21. When the truck 20 reaches its destination the time and date of arrival can be placed in the log of the NRF tag 1 as an additional method of tracking the freight 11 to which tag 1 is attached. Moreover, such real-time tracking can be carried out via the internet if IP addresses are provided for the server 19 or for individual NRF tags 1.

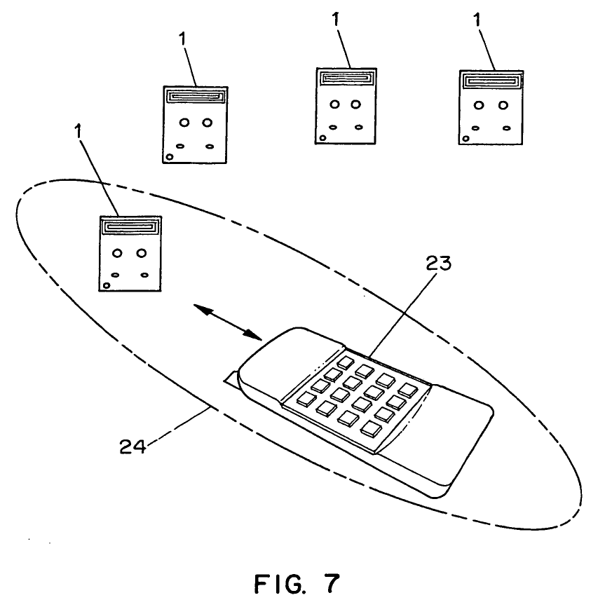

FIG. 7 shows the handheld reader 23 with a limited transmission and reception range 24. By limiting the loop size of the antenna 17 (not shown) that is contained in the handheld reader 23, as well as in the tag I itself, the handheld reader 23 may be used to selectively communicate with an individual tag 1 by disposing reader 23 to within a distance of a few loop diameters of the handheld's antenna 17. This limited range ability can only be achieved easily when using low-frequency (not exceeding 1 megahertz) loop communications. This ability makes it possible to selectively read and write information to a selected tag 1 without prior knowledge of the tag's ID. Moreover, a worker may walk up to an item of freight 11 with the handheld reader 23 properly programmed and read the destination, current temperature and any other information from tag 1 by simply placing the handheld reader within 4-5 inches of the selected tag 1 and moving reader 23 back-and-forth along the direction of the 2-headed arrow, in much the same way as a bar-code might be scanned.

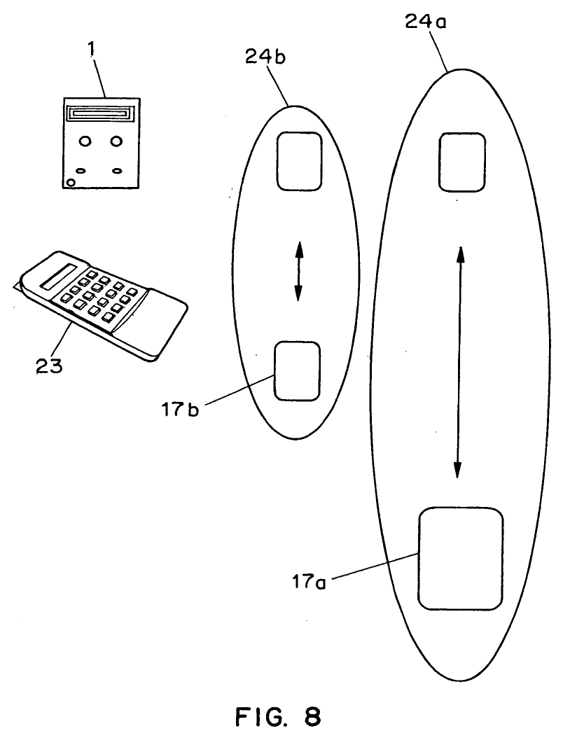

FIG. 8 shows that the distance between the hand-held and the tag for effective communications may be altered by simply changing the size of the small loop antennas 17. If a large antenna 17a is used in the handheld reader 23, the transmission reception range (Rx/Tx) 24a can be several feet, while the Rx/Tx range 24b of a smaller antenna 17b may be limited to several inches. This ability to alter the range by antenna design 17 makes programmability and reading simple and low-cost.

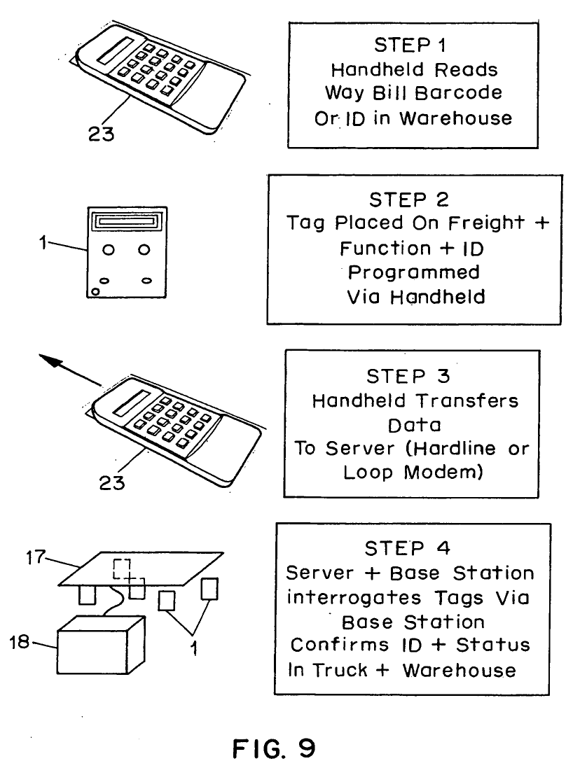

FIG. 9 shows a typical flowchart for use of these freight NRF detection tags 1. In Step 1, the handheld reader (“handheld”) 23 may read a bar-code or simply be manually programmed to write to the tag 1 at the shipment location. The waybill number or ID number may thus be programmed into the tag 1.

In Step 2 the tag 1 may be placed on the freight box 11, with tape, TAF, or other attachment means. The tag 1 may also be programmed with its ID and other information after tag 1 is attached to the freight 11. Again, this can be done with the handheld reader 23.

In Step 3, the handheld 23 transfers, to the server 19 (not shown), the data and information that handheld 23 has programmed into the tag 1. This information may include the waybill number, shipment ID or other specific information that allows the large array antenna 17 of the base station 18 (see FIGS. 5 and 6) to identify and read tags 1 throughout the shipment life cycle for a freight package 11. This data transfer may take place through the loop antenna 17 in the same way that the tag I and large loop antenna 17 communicate, or it may take place with a modem and phone line, or it may take place with a plug connected directly to the server 19 and the handheld 23.

At Step 4, the base station large antenna array 17 can now freely interrogate tags 1 to track, sort and identify the freight 11 as it moves through the warehouse/truck delivery supply chain.

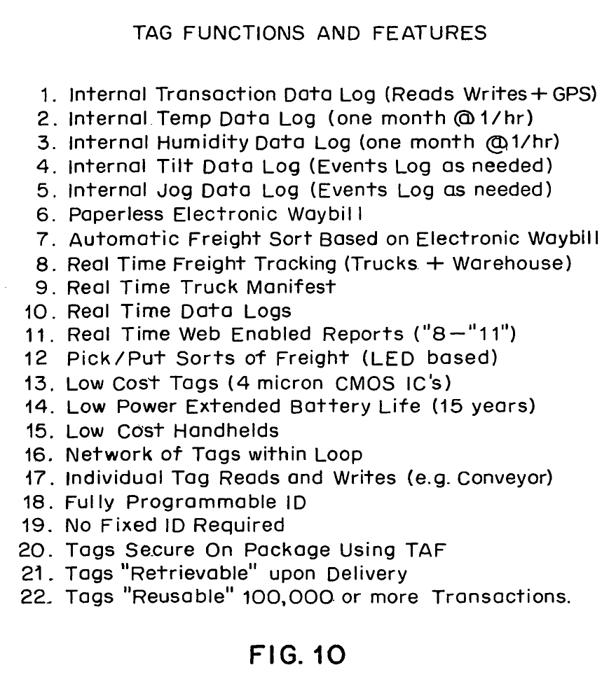

FIG. 10 lists a number of functions and advantageous features unique to the low frequency RF tags, method, and system of the invention, as follows:

1.Internal Transaction Data Log (Reads Writes+GPS)

2.Internal Temp Data Log (one month@1/hr)

3.Internal Humidity Data Log (one month@1/hr)

4.Internal Tilt Data Log (Events Log as needed)

5.Internal Jog Data Log (Events Log as needed)

6.Paperless Electronic Waybill

7.Automatic Freight Sort Based on Electronic Waybill

8.Real Time Freight Tracking (Trucks+Warehouse)

9.Real Time Truck Manifest

10.Real Time Data Logs

11.Real Time Web Enabled Reports (“8-”11”).

12.Pick/Put Sorts of Freight (LED based)

13.Low Cost Tags (4 micron CMOS IC's)

14.Low Power Extended Battery Life (15 years)
due to Low Frequency RF (<1 MHz), for example 300 KHz

15.Low Cost Handhelds

16.Network of Tags within Large Loop Antenna

17.Individual Tag Reads and Writes (e.g. Conveyor)

18.Fully Programmable ID

19.No Fixed ID Required

20.Tags Secure On Package Using TAF

21.Tags “Retrievable” upon Delivery

22.Tags “Reusable” 100,000 or more transactions.

### Passport and ID Card Embodiments

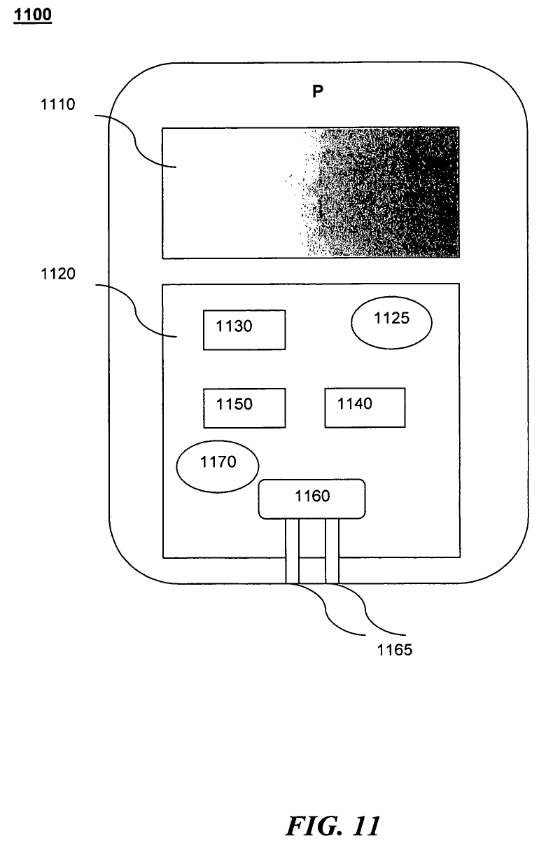

FIG. 11 shows an identification device in the form of passport P 1100 for identifying individuals. The passport P 1100 comprises a visual display portion 1110 operable to display identification data (e.g. photo, textual information) relating to an individual, as well as a wireless communication portion 1120 operable to receive data queries and transmit data wirelessly. As shown in FIG. 11, the aforesaid wireless communication portion 1120 comprises an antenna 1125, transceiver 1130, data storage device 1140, data processor 1150, and energy source 1160. The wireless communication portion 1120 is operable at a low radio frequency not exceeding 1 megahertz, which permits a low rate of energy consumption and thus extends the life of the energy source 1160 where it is a stored energy source, such as a battery (up to 15 years). The transceiver 1130 is operatively connected to antenna 1125 and is operable to transmit and receive data at the aforesaid low radio frequency (e.g. 128 hertz). The data storage device 1140 (e.g. a flash memory or the like) is operable to store data comprising the individual's name, passport number and date and place of issuance or other identification data for identifying the individual. Data processor 1150 is programmed and operable to process data received from the transceiver 1130 and from data storage device 1140 and to send data to cause the transceiver 1130 to emit an identification signal based upon the aforesaid identification data stored in the data storage device 1140.

Energy source 1160, which is operable for activating transceiver 1130 and data processor 1150, may be a rechargeable battery with a pair of connectors 1165 which can be used to charge the battery. Alternatively, the energy source 1160 is selected from a long-life replaceable battery, a solar cell, a pair of electrical connectors connectable to a mating pair connectors extending to a power supply, and a tag energization antenna operable to receive radio frequency energy from an ambient radio frequency field of a second radio frequency.

Advantageously, data storage device 1140 can store a temporal history of data queries that have been received by the passport P 1100. Moreover, data processor 1150 may be programmed to cause transceiver 1130 to automatically transmit this temporal history at the low radio frequency upon receipt by transceiver 1130 of a data signal that corresponds to the identification data stored at data storage device 1140.

As shown in FIG. 11, wireless communication portion 1120 comprises a clock 1170 operable to emit clock signals. Data processor 1150 receives the clock signals and is programmed to encrypt the stored data in response to the received data and to the clock signals for transmission by transceiver 1130 as encrypted data. The clock 1170 may, of course, include a crystal oscillator (an electronic circuit that uses the mechanical resonance of a vibrating crystal of piezoelectric material to create an electrical signal with a very precise frequency which is commonly used to keep track of time). As will be understood, the energy source 1160 also serves to activate clock 1170. Thus it is preferred that a battery (replaceable or rechargeable) be used as the energy source 1160 because the clock 1170 must be energized continuously in order to give an accurate timing signal. Techniques to carry out suitable encryption are well known to persons skilled in the security field. For example, reference may be had to U.S. Pat. No. 5,598,475, issued Jan. 28, 1997, U.S. Pat. No. 6,154,544, issued Nov. 28, 2000, and to U.S. Pat. No. 7,049,963, issued May 23, 2006; each of these three US patents is incorporated herein by reference.

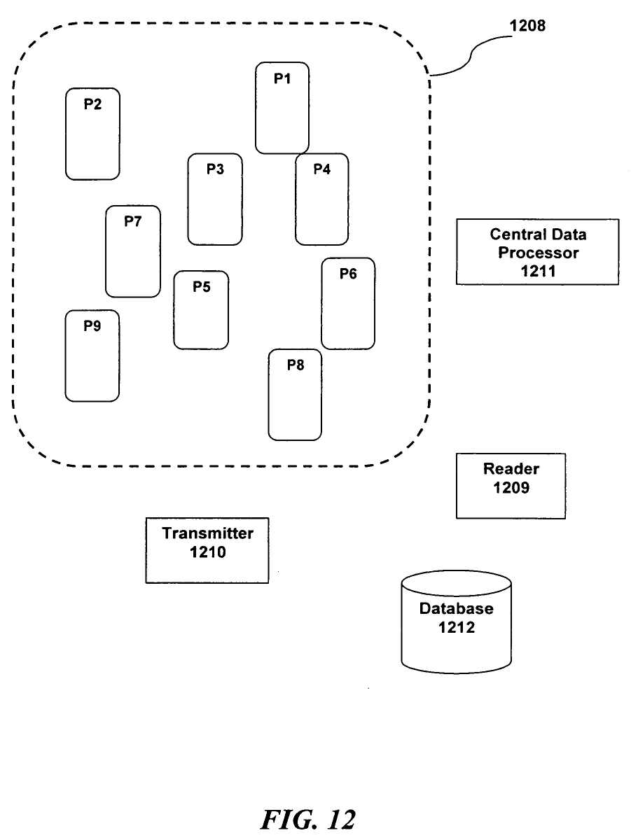

FIG. 12 shows a system for monitoring identification data relating to individuals at a border control point of entry. The system comprises an identification device, such as a passport, which is carried by each individual. Each of the passports, denoted as P1 to P9 in FIG. 12, comprises the components described hereinabove and shown in FIG. 11.

The system shown in FIG. 12 further comprises a field communication antenna 1208, a reader 1209, a transmitter 1210, a central data processor 1211 and a stored database 1212. Field communication antenna 1208 is disposed within a distance from each passport P1-P9 to permit effective communication with passports PI-P9 at the selected low radio frequency (e.g. 450 hertz). Reader 1209 is in operative communication with the field communication antenna 1208 and receives identification data (and encrypted data where encryption has been carried out) from each passport P1-P9. Transmitter 1210, which may typically comprise an oscillator at the selected communication frequency, is in operative communication with field communication antenna 1208 to send a data query to each of passports.P1-P9. Because loop antenna 1208 surrounds passports P1-P9 the entire group of passports may be queried at a distance, without need for a proximity reader, where such group queries are appropriate (e.g. to find a selected individual within the group of passports P1-P9). Central data processor 1211 is in operative communication with reader 1209 and transmitter 1210 to transmit a data query and thereafter receive the encrypted identification data and to cause a search of a database 1212 using the encrypted identification (ID) data.

According to a preferred embodiment, the aforesaid field communication antenna 1208 comprises a large loop arranged to encircle a plurality of individuals each carrying a national passport, at a border control point.

Preferably, the aforesaid energy source comprises a tag energization antenna operable to receive radio frequency energy from an ambient radio frequency field of a second radio frequency, the aforesaid system further comprising a field energization antenna operable to produce the aforesaid ambient radio frequency at the tag energization antenna of the aforesaid individual.

While the present invention has been described with reference to preferred embodiments thereof, numerous obvious changes and variations may readily be made by persons skilled in the fields of radio frequency tags and logistics. Accordingly, the invention should be understood to include all such variations to the full extent embraced by the claims.

Therefore, while there has been described what is presently considered to be the preferred embodiment, it will understood by those skilled in the art that other modifications can be made within the spirit of the invention.

We claim:

1. An identification device for identifying an entity, said identification device comprising:
a) a visual display portion operable to display identification data relating to the entity;
b) a wireless communication part operable to receive data queries and transmit data wirelessly in response to the data queries, said wireless communication part comprising:
i) an antenna operable at a low radio frequency not exceeding 1 megahertz;
ii) a transceiver operatively connected to said antenna, said transceiver being operable to transmit and receive data at said low radio frequency;
iii) a data storage device operable to store data comprising identification data for identifying the entity;
iv) a data processor operable to process data received from said transceiver and said data storage device and to send data for causing said transceiver to emit an identification signal based upon said identification data stored in said data storage device; and
v) an energy source operable for activating said transceiver and said data processor.

2. The identification device of claim 1, wherein said energy source comprises a rechargeable battery.

3. The identification device of claim 1, wherein said energy source comprises a replaceable battery.

4. The identification device of claim 1, wherein said energy source comprises a solar cell.

5. The identification device of claim 1, said energy source comprising a pair of electrical connectors connectable to a mating pair of connectors extending to a power supply.

6. The identification device of claim 1, said energy source comprising a tag energization antenna operable to receive radio frequency energy from an ambient radio frequency field of a second radio frequency.

7. The identification device of claim 1, said identification device comprising identification data of a national citizen, said visual display part comprising a photographic image of the citizen together with textual information relating thereto.

8. The identification device of claim 1, wherein said data storage device is operable to store a temporal history of data queries that have been received by said identification device.

9. The identification device of claim 8, wherein said data processor is programmed to cause said transceiver to automatically transmit said temporal history at said low radio frequency upon receipt by said transceiver of a data signal that corresponds to said identification data stored at said data storage device.

10. The identification device of claim 1, wherein said wireless communication part comprises: a clock operable to emit clock signals, said data processor operable to receive said clock signals and programmed to encrypt the stored data in response to the received data and said clock signals for transmission by the transceiver as encrypted data, said energy source operable for activating said clock.

11. The identification device of claim 1 wherein the identification device further comprises:
at least one sensor located on the front of the identification device, the at least one sensor for detecting a condition which may affect the entity associated with the identification device.

12. The identification device of claim 1 wherein
a front surface of the identification device is gently curved to form an ellipse for providing a continuous surface for affixing an adhesive to hold the identification device securely on the entity, the elliptical shape also for eliminating sharp edges; and wherein
a back surface of the identification device is a planar surface for making full contact with the entity once it is secured onto the entity.

13. The identification device of claim 12 further comprising:
a plurality of buttons located on the back surface, the buttons formed of a compliant material which is easily deformed and with sufficient tensile strength such that the buttons can acquire their original shape after deformation; the buttons, when depressed, confirm that the identification device is affixed to the entity.

14. The identification device of claim 13 wherein the buttons comprise identifying characters associated with each button such that the buttons can be used to input data by depressing the buttons in a certain sequence.

15. The identification device of claim 1 further comprising:
an adhesive attachment film for affixing the identification device to the entity.

16. A method for monitoring identification data relating to an entity, comprising steps of:
A) providing an entity with an identification device, said identification device comprising:
a) a display for displaying identification data relating to the individual;
b) a wireless communication part operable to receive data queries and transmit data wirelessly, said wireless communication portion comprising:
i) an antenna operable at a low radio frequency not exceeding 1 megahertz;
ii) a transceiver operatively connected to said antenna, said transceiver being operable to transmit and receive data at said low radio frequency;
iii) a data storage device operable to store data comprising identification data for identifying said entity;
iv) a data processor operable to process data received from said transceiver and said data storage device and to send data to cause said transceiver to emit an identification signal based upon said identification data stored in said data storage device;
v) a clock operable to emit clock signals, said data processor being operable to receive said clock signals and being programmed to encrypt the stored data in response to the received data and said clock signals for transmission by the transceiver as encrypted data; and
vi) an energy source operable for activating said transceiver, said clock and said data processor;
B) sending said received data as a data query to said identification device; and
C) thereafter receiving said encrypted data and searching a database therewith.

17. The method of claim 16, wherein said identification device is a passport.

18. A system for monitoring identification data relating to an entity, said system comprising:
A) an identification device comprising:
1) a display for displaying identification data relating to the entity;
2) a wireless communication part operable to receive data queries and transmit data wirelessly, said wireless communication part comprising:
a) an antenna operable at a low radio frequency not exceeding 1 megahertz;
b) a transceiver operatively connected to said antenna, said transceiver being operable to transmit and receive data at said low radio frequency;
c) a data storage device operable to store data comprising identification data for identifying said entity;
d) a data processor operable to process data received from said transceiver and said data storage device and to send data to cause said transceiver to emit an identification signal based upon said identification data stored in said data storage device;
e) a clock operable to emit clock signals, said data processor being operable to receive said clock signals and being programmed to encrypt the stored data in response to the received data and said clock signals for transmission by the transceiver as encrypted data; and
f) an energy source operable for activating said transceiver, said clock and said data processor;
B) at least one field communication antenna disposed within a distance from each identification device that permits effective communication therewith at said low radio frequency;
C) a reader in operative communication with said field communication antenna, said reader operable to receive encrypted data from said identification device;
D) a transmitter in operative communication with said field antenna, said transmitter operable to send a data query to said identification device; and
E) a central data processor in operative communication with said reader and transmitter to transmit a data query and thereafter receive said encrypted data and to cause search of a database therewith.

19. The system of claim 18, wherein each identification device comprises an identification document, and wherein the field communication antenna comprises a large loop arranged to encircle a plurality of entities each bearing the identification document.

20. The system of claim 19, said energy source comprising a tag energization antenna operable to receive radio frequency energy from an ambient radio frequency field of a second radio frequency, said system comprising a field energization antenna operable to produce said ambient radio frequency at the tag energization antenna of said entity.
